(19) United States
(12) Patent Application Publication
(10) Pub. No.: US 2011/0250576 A1
(43) Pub. Date: Oct. 13, 2011

(54) System and method for recovering form addictions

(76) Inventor: Reid Kevin Hester, Albuquerque, NM (US)

(21) Appl. No.: 13/134,944

(22) Filed: Jun. 21, 2011

Related U.S. Application Data
(63) Continuation-in-part of application No. 12/661,337, filed on Mar. 16, 2010.

(51) Int. Cl. G09B 19/00

(52) U.S. Cl. 434/236

(57) ABSTRACT

The present invention relates to a system and method for helping people abstain from addictive behaviors by utilizing an Internet-based software program to build a users' motivation to abstain, develop coping strategies for dealing with urges and cravings, learn how to analyze their behavior in terms of established goals and solve problems that impede their progress, to set goals and develop healthy, pro-social activities, and to develop a specific plan to change their behaviors. An automated but personalized email system encourages their persistence in continuing with their recovery plan, reminds them of their identified triggers, strategies they've chosen to deal with them, and reminders to engage in the pro-social activities they've chosen. A smartphone application, in addition to the features of the email method, includes a personalized text messaging feature for reaching out to others for social support.

### CROSS REFERENCE TO RELATED APPLICATIONS

This application is a continuation in part of patent application Ser. No. 12/661,337.

### STATEMENT REGARDING FEDERALLY SPONSORED R&D

This invention was made with Government support under Small Business Innovative Research Grant 1 R44-AA016237 “An Internet Application for SMART Recovery” awarded by the National Institute of Alcohol Abuse and Alcoholism of the National Institutes of Health. The Government has certain rights in the invention.

### BACKGROUND OF THE INVENTION

1. Field of the invention

The present invention relates to a system and method for helping people abstain from addictive behaviors by utilizing an Internet-based software program to build a users' motivation to abstain, develop coping strategies for dealing with urges and cravings, learn how to analyze their behavior in terms of established goals and solve problems that impede their progress, to set goals and develop healthy, pro-social activities, and to develop a specific plan to change their behaviors. The method includes an automated but personalized email system that encourages their persistence in continuing with their recovery plan, reminds them of their identified triggers and strategies they've chosen to deal with them, and reminders to engage in the pro-social activities they've chosen. The method also includes a smartphone application that, in addition to the features of the email method, includes a personalized text messaging feature for reaching out to others for social support.

2. Description of Prior Art

Programs for Recovering from Addictions. While the predominant model for addressing addictive behaviors in the U.S. is the 12-step model (e.g., Alcoholics Anonymous, Narcotics Anonymous, etc.), a significant proportion of people who are looking for help with their addictions reject 12-step programs for a variety of reasons (Institute of Medicine, 1990). At least some of these people are interested in viable alternative recovery options—often preferring approaches that provide them with more flexibility in how they define and address their addictive behavior(s). A program like SMART Recovery provides such individuals with a program that, like a 12-step program, employs the use of interactive group components (face-to-face meetings, online meetings via web-based “chat” rooms, an online forum, and a self-help handbook, the SMART Recovery Handbook (Steinberger, 2004). However, SMART Recovery fundamentally differs from the 12-step model in that it: 1) avoids labeling (e.g., “alcoholic” or addict“) (unless individuals themselves accept that label); 2) does not promote acceptance of addiction as a disease, per se (but is accepting of members' views of addiction as a disease); and 3) encourages a science-based approach to recovery. Anecdotal evidence from SMART Recovery meetings indicates that these aspects of the program are reasons why participants are drawn to SMART Recovery.

SMART Recovery's menu of cognitive-behavioral and motivational strategies has been adapted from treatment interventions and addresses the different Stages of Change (Connors et al., 2001). The SMART Recovery protocol, however, is not a direct outgrowth of the Stages of Change model. Rather, it has gradually evolved based on empirical evidence of “what works” in helping people with addictions (Miller, et al., 2003). Its elements are designed to help members address issues ranging from basic motivation for change to qualitative lifestyle changes intended to reduce the appeal of, and engagement in, harmful addictive behaviors. The availability of additional abstinence-based self-help programs like SMART Recovery is essential to providing those who reject traditional 12-step approaches with alternative self-directed recovery options.

Data is also mounting that the public is increasingly turning to the Internet for information, assistance, and support for a variety of issues (Taylor & Luce, 2003). As of December 2008, Nielsen/Net Ratings indicate that there were 248,241,969 Internet users in North America which is 73.6% of the estimated population and represents a 130% increase since 2000 (Internet World Stats, 2008). Many search the Internet for health oriented information. The Pew Internet and American Life Project estimate that 78% of American Internet users searched for at least one major health topic online in 2006 (pewinternet.org/PPF/r/190/report_display.asp). About 28% of Internet users have attended at least one online support group (www.pewinternet.org). The public information web site of NIMH receives 7,000,000 hits per month.

There is a growing body of literature demonstrating the effectiveness of computer-based and online interventions for addictions, mental health disorders, and health-related diseases. As one indication of this body of research The Journal of Medical Internet Research (www.jmir.org) is in its 11^{th} year of online publication, publishing four issues online per year with 53 articles in 2008, including three reviews of the literature. The following are some examples of recent studies.

The Drinker's Check-up (DCU) The DCU has demonstrated evidence of effectiveness in a randomized clinical trial, finding reductions in drinking between 45 and 55% at 12 months follow-up (Hester, Delaney, & Squires, 2005) across a broad range of heavy drinkers.

ModerateDrinking.com is a moderation oriented program for heavy, non-dependent drinkers who are interested in cutting back on their drinking. Results of a randomized clinical trial found that participants who used the Internet application drank less at follow-up when compared to the control group (Hester, Delaney, Campbell, & Handmaker, 2009, Hester, Delaney, & Campbell, 2011).

Riper and colleagues (2007) evaluated a cognitive-behavioral web application for problem drinkers in a randomized trial in the Netherlands, comparing it to an online psychoeducational brochure. At 6-months follow-up they found significantly greater reductions in drinking in the experimental group when compared to the control group.

Kay-Lambkin and colleagues (2008) reported 12 month outcomes of a randomized trial that compared a brief intervention (BI) to nine sessions of motivational interviewing and cognitive-behavioral therapy (MI/CBT). The interventions addressed co-morbid major depression and alcohol/cannabis misuse. Individuals in the MI/CBT condition were further randomized to receive the intervention via face-to-face individual therapy or via a computer-based program (with brief weekly input from a psychologist). They found that depression responded better to MI/CBT than BI alone and those in the face-to-face MI/CBT condition had better outcomes than the computer-based intervention at 3 months (although they were equivalent at 12 months). The MI/CBT group also had better outcomes than the BI condition on alcohol and cannabis use and the computer-based intervention demonstrated the largest treatment effect.

Carroll and colleagues (2008) evaluated the efficacy of a computer-based cognitive behavioral program for addictions in a randomized clinical trial with 77 individuals in treatment for substance abuse. Using an additive design they found that individuals receiving the computer-based intervention had better outcomes on clean urines and longer continuous periods of abstinence during treatment compared to those who received only the treatment program as usual. They concluded that the program is an effective adjunct to outpatient treatment.

Calbring and Smit (2008) combined an Internet-based program with minimal therapist contact (i.e., email and brief weekly phone calls) for problem gamblers. They found significant improvements in gambling measures, anxiety, depression, and quality of life at follow-ups. Large effect sizes were reported at follow-ups up to 36 months.

The alcohol-specific program by Kay-Lambkin described above [0010] is deficient in two ways. First it involves personal contacts with therapists and this aspect significantly hinders its widespread dissemination outside of substance abuse treatment programs. Second, the clinical magnitude of the changes in consumption is modest. Programs with larger effects are needed.

The alcohol-specific program by Caroll described above [0011] is deficient in two ways. It also involves personal contacts with therapists and this aspect significantly hinders its widespread dissemination outside of substance abuse treatment programs. Second, the clinical magnitude of the changes in consumption is modest.

The program by Calbring and Smit described above [0012] is also deficient in two ways. They involve personal contacts with therapists and this aspect significantly hinders its widespread dissemination outside of substance abuse treatment programs.

Second, the program only focuses on compulsive gambling and does not include the more prevalent addictive behaviors: drinking and drug use.

The DCU program that I developed and is described above [0007] is also deficient. It is a brief motivational intervention and is not an abstinence-oriented program [0007]. It does not show users how to stop drinking and prevent relapse, it only motivates them to do so.

The ModerateDrinking.com program I developed is also deficient in two ways [0008]. First, it addresses only drinking, not other addictive behaviors. Second, it is oriented towards moderation as a goal of change for non-dependent drinkers, not abstinence for dependent drinkers. This invention addresses these deficiencies.

U.S. patent application Publication No. 6,439,893 of Jacqueline Byrd et al., published on Aug. 27, 2002, titled: Web based, on-line system and method for assessing, monitoring and modifying a given behavioral characteristic which discloses a system and method for interactively assessing at least one characteristic of a user on-line, developing a personal growth strategy and monitoring the person's progress with respect to the personal growth strategy.

The Byrd et al. program is deficient in six ways. First, it does not specifically address substance use and addiction-related problems which are necessary to provide the skills needed to recover from addictive behaviors. Second, it does not address the issues of motivation for changing a person's addictive behaviors. It is a purely action-oriented system and method. Third, it does not provide personalized feedback about the effectiveness of the user's strategies to manage urges and cravings. Fourth it does not teach users how to effectively refuse drinks, drugs, or offers to go gambling. Fifth, it does not teach users how to functionally analyze their behaviors and how to challenge their dysfunctional thoughts and feelings that can lead to relapse. Sixth, it does not have any evidence of effectiveness in the treatment outcome literature (Miller et al., 2003).

A second related patent is U.S. Pat. No. 7,024,398 of Michael Kilgard et al., published on Apr. 4, 2006, titled: Computer-implemented methods and apparatus for alleviating abnormal behaviors; which discloses systems and methods for alleviating abnormal behavior. This patent is deficient for the same reasons as detailed in paragraph [0019].

A third related patent is U.S. Pat. No. 5,967,789 published on Oct. 19, 1999, titled: Method and System for stopping or modifying undesirable health-related behavior habits or maintaining desirable health-related behavior habits. This patent is deficient for the same reasons as detailed in paragraph [0019].

A fourth related patent is U.S. Pat. No. 7,376,700 B1 of Paul Clark et al., published on May 20, 2008, titled: Personal coaching system for clients with ongoing concerns such as weight loss; which discloses a system for coaching a number of clients that involves matching clients to coaches based on client input, and initiation of the coaching relationship with a set of recommendations also based on the client's input. This patent is deficient for the same reasons as detailed in paragraph [0020].

### SUMMARY OF THE INVENTION

The present invention is different from the prior art. The program is a stand-alone, cognitive-behavioral intervention that helps users achieve and maintain sobriety from drinking, drug use, and abstinence from compulsive gambling. It has methods for enhancing and maintaining motivation for changing a person's addictive behaviors. It provides personalized feedback about the effectiveness of the user's strategies to manage urges and cravings. It also teaches users how to effectively refuse drinks, drugs, or offers to go gambling. It teaches users how to functionally analyze their behaviors and how to challenge their dysfunctional thoughts and feelings that can lead to relapse. These strategies are well validated in the face-to-face clinical protocols to achieve these goals. Consequently the program promises to have a large impact on users. Finally, the program combines interactivity in the process of enhancing motivation to abstain, automated monitoring of progress, and customized and personalized email and text messages that facilitate continued engagement with both the program and the user's plan for recovery.

It is an object of the present invention to provide a system and methods for helping individuals abstain from addictive behaviors.

It is another object of the present invention to provide a system comprised of a computer with a web browser and printer for users and an Internet-based database for storage and retrieval of user input.

It is another object of the present invention to provide a therapeutic intervention for individuals that comprises: an internet-based software program to build a users' motivation to abstain, develop coping strategies for dealing with urges and cravings, learn how to analyze their behavior in terms of established goals and solve problems that impede their progress, to set goals and develop healthy, pro-social activities, and to develop specific plans to change their behaviors.

It is another object of the present invention to provide an email system that comprises: an automated, personalized set of emails delivery of which is based on users' input into the program that encourages their persistence in continuing with their recovery plan, reminds them of their identified triggers and strategies they've chosen to deal with them, and reminders to engage in the pro-social activities they've chosen. The method also includes a cell phone application that, in addition to the features of the email method, includes a personalized text messaging feature for social support.

It is another object of the present invention to provide cell phone application that comprises: a personalized text messaging feature for social support in addition to text messages with the same function as those of the email system.

### BRIEF DESCRIPTION OF THE DRAWINGS

FIG. 1 shows a system illustrating the interaction between the software program, the data set, and the user.

FIG. 2, is the first section of a flow diagram illustrating the method of the clinical intervention.

FIG. 3 is a continuation of FIG. 2 with the second section of a flow diagram illustrating the method of the clinical intervention.

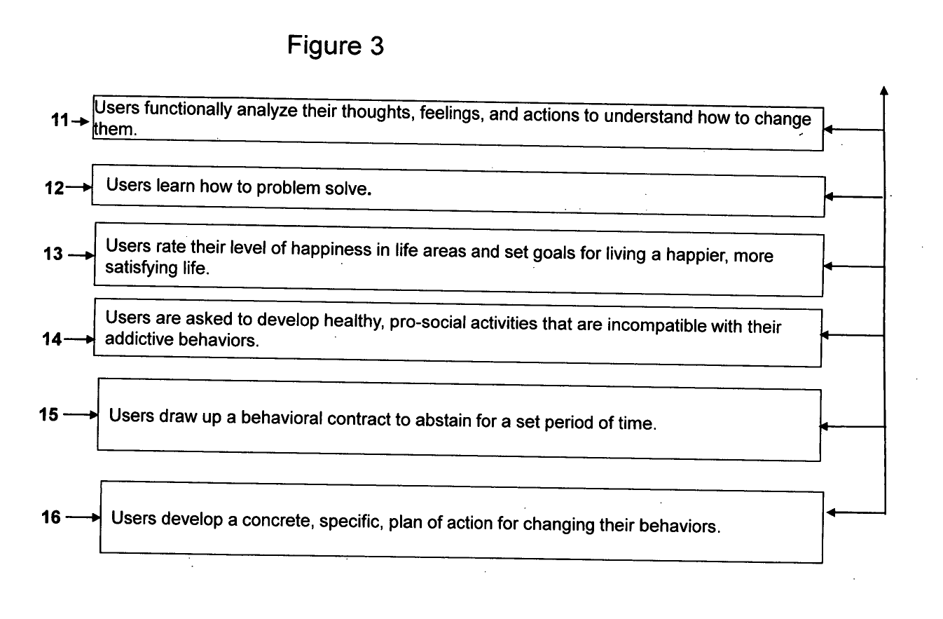

FIG. 4 is a continuation of FIG. 3 with a third section of a flow diagram illustrating the method of the clinical intervention.

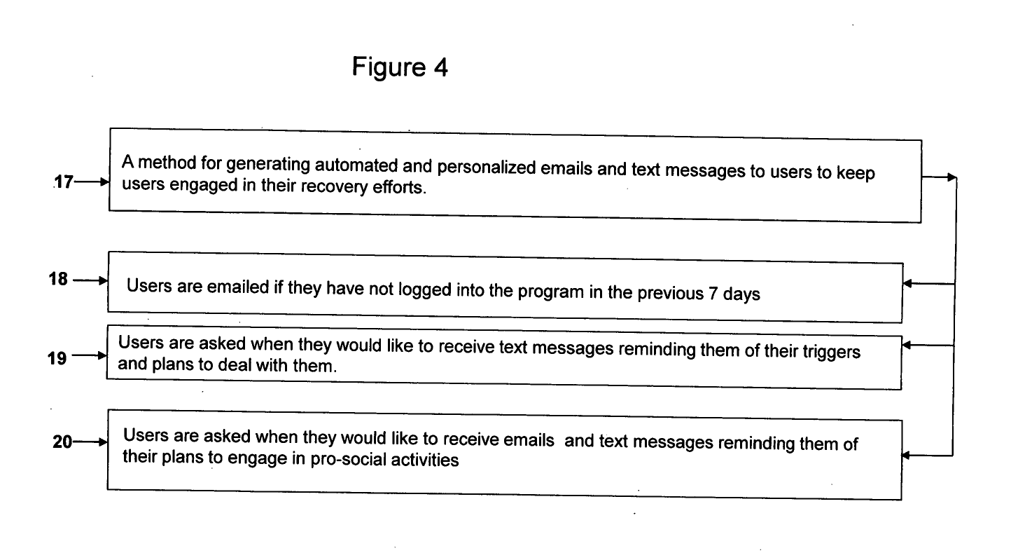

### DETAILED DESCRIPTION OF THE INVENTION

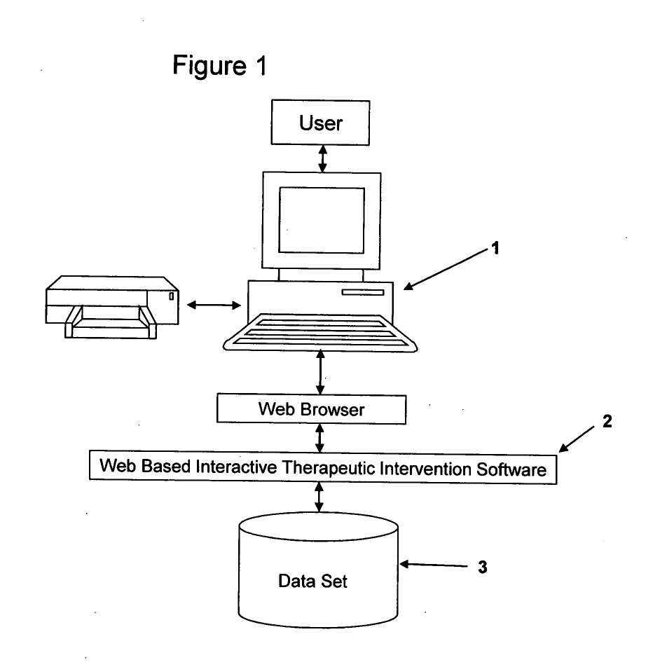

FIG. 1 shows a flow diagram of the best mode of the present invention's system. The system comprises a computer and printer for the user, interactive software that provides cognitive behavioral training program for the user, and an Internet-based relational database that collects and saves the input of the user and provides the basis for the individualized interactions in the modules of the intervention software.

In the best mode of the present invention the computer 1 used by the user can have any operating system as long as it has a web browser installed on it.

In the best mode of the present invention the computer 2 hosting the relational database on the Internet is a web server capable of running a Microsoft ASP.NET software application and a MySQL database.

In the best mode of the present invention the software program that provide the methods for achieving 3, 4, & 17 for the user and for the administrator is a Microsoft ASP.NET program in a web-based execution.

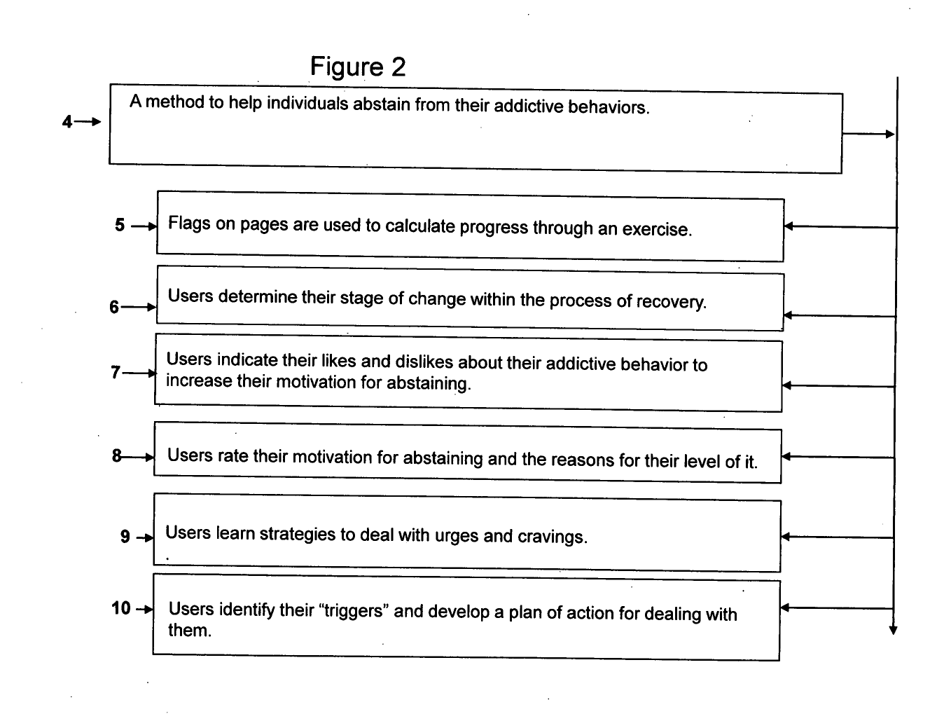

FIG. 2 shows a flow diagram of the best mode of the present invention's method for administering the therapeutic intervention to the user.

The program begins when users sit down at the computer 1, opens a web browser and navigates to the site of the program on the Internet. Registration is accomplished via an online form 2-3 with an email confirmation. During registration users also set up their automated yet customized email and text messaging options 17 and the individuals to which they want to be able to send personalized text messages to 20 when they are in need of social support in their My Account page. This is also when they first choose which addictions they want to focus on.

Once users complete their registration, the program takes them to their designated home page for the addictive behavior (alcohol, marijuana, stimulants, opioids, or compulsive gambling) they want to focus on in that online session. Each module is separate but also shares some data input of a particular user between his or her modules. This home page is set up in a table that has rows grouped by the major strategies: motivation; urges; self-management; lifestyle management; and goal setting. Within each of these strategies are individual sets of exercises. For example, in the motivation module the exercises are: values clarification; a cost-benefit analysis; and increasing one's desire, commitment, and self-confidence in changing. Each of these individual sets of exercises has a separate column indicating the user's progress 5 in that exercise: Blank (for not yet started); In Progress; and Completed with a column following that shows the date first completed. These status indicators are set when users arrive on specific pages within particular exercises.

Users first are asked to assess where they are in the process of changing their addictive behaviors 6. The intervention describes these stages of change (pre-contemplation, contemplation, determination, action, relapse) and provides links to exercises within the program depending on the particular stage the person is in. For example, the program will suggest to a person who is still thinking of changing (in contemplation) that he or she focus attention on the motivation exercises to help them resolve their ambivalence about changing.

Most users first need to increase their internal motivation for change. The program helps them by asking them to list the “good things” and the “not so good things” they like about drinking, their drug of choice, or their gambling (depending on the addiction they are focusing on). The list of “good things” is usually fairly short while the list of “not so good things” (negative consequences) is often quite long. Users are then asked to rank order the importance of their “good things” and “not so good things” and then compare the two. This exercise of listing the positives and negatives of an addictive behavior helps users think more clearly about their addiction and it tends to help them resolve their ambivalence about becoming abstinent.

Users are then given another exercise, to rate their need, desire, commitment, and self-confidence to abstain on a scale from 0-10 8. They are then asked what makes them an x and not an x−2. For instance if they rate their desire to abstain as a 6, the program asks them what makes them a 6 and not a 4. The reply draws out what is known as “change talk” in motivational enhancement theory (Moyers & Martin, 2006). Users are also asked about their success in changing other addictions or bad habits in the past as well as their strengths that they could bring to bear on recovering from their addiction. As the end of the exercise, the input is presented in a summary form with a recommendation to print out the page and think about what the users have said in these exercises.

The set of exercises dealing with urges and cravings is the next method 9 offered to users. It presents them with written, oral, and video examples and instructions for dealing with urges and cravings. The strategies include avoidance, distraction, questioning the urge, detached observation of the urge over time, and meditation). Users also are asked to self-monitor their urges and cravings over time noting the duration, intensity, and the coping strategies they used to deal with them. When these data are entered into the program, they are saved to the database 3 and the program then provides personalized feedback about their progress in reducing their urges and cravings as measured by frequency, duration, and intensity.

Another method is to ask users identify triggers to their urges and cravings (and subsequent drinking, drug use, or gambling), then helping them develop concrete, specific plan for dealing with their specific triggers 10. Potential domains of triggers include when (time of day, day of week), where (home, bars, etc.), with whom (friends, family, spouse), activities (watching football, making dinner), internal states (feelings, acute or chronic pain, medical conditions), family related stressors, money related stressors, and major life events (death in family, loss of job, retirement). Once users select from this list of domains the program asks for more detail that it uses in the subsequent section on managing these triggers. It also presents the final list as high risk situations for users to relapse. And this leads to the next exercise of managing triggers.

In the managing triggers exercise 10, the program dynamically displays those triggers selected in the “identify triggers” exercise and then addresses each trigger in turn by suggesting strategies to deal with the trigger. Users then specify their own plan for addressing a specific trigger in the form of an “If . . . then . . . ” statement. For example, a user might enter “If John comes over with a 6 pack of beer and wants to share it, then I'll politely but firmly refuse to join him in drinking and ask for his support in my efforts to remain abstinent.”

The next method in the intervention is having users learn how to functionally analyze their behaviors to help them help them understand how their thoughts, feelings, and actions work together. It can also help them change the ways they think, feel, and react to situations 11. The exercise is called an “ABC” (activating event or trigger, beliefs and behavior, and consequences). Examples are presented in text and a video clip that show how a person can go through the exercise. In the Activating event the questions are “What happened? What did someone else do or say?” The B aspect of the exercise asks for the user's thoughts, beliefs, and expectancies. The C is short for consequences, both short and long-term. Following this users are asked to D, dispute the thoughts that are self-defeating (with examples of such thoughts provided), E, come up with effective new thoughts to replace the self-defeating thoughts, and E, examining the likely effective new consequences of thinking about the situation differently. The ABC exercises input by users are saved in the database for future retrieval and consideration. They are also presented in a summary form at the end of the exercise for the user to print out a hard copy.

Users next learn how to problem solve 12. The sequence is presented in text and on a video clip. The steps are: 1. Define the problem narrowly. Describe the problem in a way that is brief and measurable. 2. Think creatively of possible solutions. Don't evaluate at this point. Think “outside the box!” 3. Now evaluate the solutions. Consider the consequences of each solution. Drop solutions that are not practical or have undesired consequences. 4. Pick one potential solution. 5. Think of possible barriers. What or who could get in your way of trying this solution? 6. Address each obstacle. How can you respond to each obstacle or barrier? Be specific. 7. Try out the solution if it still looks like it will be helpful. 8. Evaluate what happened. Note what happened and how well it worked (rather than a yes it worked or no it didn't). If the solution didn't work well enough, perhaps you need to keep at it. Do you need to refine the solution or try another solution? Their problem solving exercises entered into the program are also saved for future retrieval and summarized at the end of the exercise.

The next method asks users to rate their level of happiness in ten domains of life (e.g., social, personal life) at the moment that they are doing the ratings 13. They are then asked to choose an area of moderate dissatisfaction they would like to see improvement in. The next step is to ask what their life would look like if their rating was higher, then setting specific, measurable, achievable, realistic, and time specific goals to improve their level of happiness in that area. This method asks them to specify the specific goal, the actions to achieve them, and the time frame in which to take those actions. The exercises entered into the program are also saved for future retrieval and summarized at the end of the exercise.

The next method asks users to identify healthy pro-social activities that are both incompatible with their addictive behaviors and that would compete for the time freed up when abstaining from addictive behaviors 14. This method includes asking what they did for fun before they started drinking, using drugs, or gambling, asks them to consider developing additional healthy, creative activities that absorb their interest, and then to consider both the short-term costs of trying a new or returning to an old activity as well as the long-term rewards from engaging in these pro-social activities. The exercises entered into the program are also saved for future retrieval and summarized at the end of the exercise.

The next method asks to create a written, behavioral contract with themselves to abstain for a set period of time 15. Taking small steps in becoming abstinent is often less overwhelming than committing to abstain for the rest of one's life. Users can then string together abstinence contracts as they become more confident in their ability to remain abstinent. This time duration is up to the user and the program suggests 30 days but will accept as little as one day. If users proceed with setting up a contract, the program discusses potential risks and problems with detox and withdrawal which vary by the addictive behavior. Alcohol and drug users are encouraged to contact their primary care physician to address these risks. The program begins the interaction of setting up a sobriety contract by asking about the “good things” users anticipate with abstaining for this period of time. It then asks users for specifics of the sobriety contract.

The contract begins on a specific data and runs for a specific period of time. A written contract is generated for them to print out and sign. The method then asks them to consider what fun things they could do during this time so that abstinence is more rewarding than drinking, using, or gambling. Users are asked to generate a list of activities and the program then presents them and users are then asked to print out hard copy of it. The final step in the method is to encourage users to ask for support from friends and loved ones.

The next method takes users through steps to develop a concrete, specific, plan of action for changing their behaviors 16 that specifies the changes both positive (increasing something) and negative (decreasing something), their reasons for changing, their steps in changing, how others can support them in their actions, what could go wrong and how they can stick with their plan despite these obstacles, and what good things will happen as a result of the changes they've specified. These change plans are saved in the database for future retrieval and review, are summarized at the end of the exercise, and users are encouraged to print a hard copy of the plan.

During registration the program asks users for their cell phone numbers and carrier (e.g., AT&T) and their email addresses that it will use to send them automated but customized text and email messages that encourage them to persist in their recovery efforts 17. The program monitors who logs into the program on a daily basis and emails users who have not logged in in the previous 7 days. The email is a carefully worded reminder for them to keep working on the program and their recovery 18.

As users then go through the program, they are asked at various points to set up when they would like to receive emails and text messages that remind them of their input into the program. For instance, when users identify triggers and their plans to address them the program will ask them when they would like to receive emails and text messages about their triggers and their plans to address them 19.

Another example is when they enter pro-social activities they plan to pursue in lieu of their addictive behaviors. At the end of that exercise the program asks them when they would like to receive email and text message 20 reminders to engage in these activities.

What is claimed is:

1. A system to help people recover from addictive behaviors comprising: a computing system able to run at a rate of at least one gigahertz and has a web browser; an Internet-based program that runs a therapeutic intervention for individual use that will be able to run within the browser on said computing system; an Internet-based database that stores and retrieves individual user's data; and a device to obtain the output of a run of individually customized data set so as to properly interface with the human subject.

2. A system as set forth in claim 1 to help people recover from addictive behaviors further comprised of a web browser-based software to coordinate, implement and manage all components of the program.

3. A system as set forth in claim 1 to help people recover from addictive behaviors further comprised of an Internet-based database that stores and retrieves individual user's data.

4. A method to help people recover from addictive behaviors comprising the steps of: setting flags within the modules of the therapeutic intervention so that when a user comes to a specific page the flag is set and the progress within that module is displayed as “in progress” or “completed” on the user's home page for that module; using a module to help the user determine his or her stage of change within the process of recovering from their addiction and then suggesting which modules and/or outside resources may benefit the user; using a module that assesses the person's likes and dislikes about their addictive behavior to increase their motivation for abstaining; using a module that measures and increases their desire, commitment, and self-confidence for abstaining; using a module that trains them in effective ways to cope with urges and track their urges and cravings and provide personalized feedback about their progress in reducing their urges and cravings; using a module that identifies and helps them develop a plan for dealing with the people, places and things that give rise to urges and cravings; using a module that helps them functionally analyze their behaviors in light of their established goals and to develop new patterns of responding to stressful situations; using a module that helps them develop problem solving strategies; using a module that helps them set goals to living a happier, more satisfying life; using a module that helps them develop healthy, pro-social activities that are incompatible with their addictive behaviors; using a module helps users create a written, behavioral contract with themselves to abstain for a set period of time; and using a module to develop a concrete, specific, plan of action for changing their addictive behaviors.

5. A method as set forth in claim 4 further comprising the step of: setting flags within the web pages of the therapeutic intervention so that when a user comes to a specific page the flag is set and the progress within that module is displayed as “in progress” or “completed” on the user's home page for that module.

6. A method as set forth in claim 4 further comprising the step of: helping the user determine his or her stage of change within the process of recovering from their addiction and then suggesting which modules and/or outside resources may benefit the user.

7. A method as set forth in claim 4 further comprising the step of: asking about and recording the person's likes and dislikes about their addictive behavior then displaying the two column results to him or her to increase his or her motivation for abstaining.

8. A method as set forth in claim 4 further comprising the step of: asking the user to rate his or her desire, commitment, and self-confidence for abstaining, saving that information into the database and then asking them a strategic question about what underlies their level of desire, commitment and self-confidence. This method theoretically should increase their level of motivation for change.

9. A method as set forth in claim 4 further comprising the step of: teaching them effective ways to cope with urges (with avoidance, distraction, questioning the urge, detached observation of the urge over time), and track their urges and cravings and provide personalized feedback about their progress in reducing their urges and cravings as measured by frequency, duration, and intensity.

10. A method as set forth in claim 4 further comprising the step of: helping users identify triggers to their urges and cravings then helping them develop a plan for dealing with their specific triggers that give rise to their urges and cravings.

11. A method as set forth in claim 4 further comprising the step of: helping users learn how to functionally analyze their behaviors to help them help them understand how their thoughts, feelings, and actions work together.

12. A method as set forth in claim 4 further comprising the step of: helping users learn problem solving skills by specifically identifying the problem, brainstorming alternative solutions, evaluating the solutions for their potential consequences and feasibility, choosing a solution, considering possible barriers, specifically addressing each barrier, trying out the solution, then evaluating what happened and deciding whether to refine the solution or try another solution.

13. A method as set forth in claim 4 further comprising the step of: asking a user to rate his or her level of happiness in ten domains of life (e.g., social, personal life), then choose an area of moderate dissatisfaction to improve, then asking them what their life would look like if their rating was higher, then setting specific, measurable, achievable, realistic, and time specific goals to improve their level of happiness. This method asks them to specify the specific goal, the actions to achieve them, and the time frame in which to take those actions.

14. A method as set forth in claim 4 further comprising the step of: asking users to identify healthy pro-social activities that are both incompatible with their addictive behaviors and that compete for the time freed up when abstaining from their addictive behaviors. This method includes asking what they did for fun before they started drinking, using drugs, or gambling, asks them to consider developing additional healthy, creative activities that absorb their interest, and then to consider both the short-term costs of trying a new or returning to an old activity as well as the long-term rewards from engaging in these pro-social activities.

15. A method as set forth in claim 4 further comprising the step of: having users create a written, behavioral contract with themselves to abstain for a set period of time.

16. A method as set forth in claim 4 further comprising the step of: helping users develop a concrete, specific, plan of action for changing their behaviors that specifies the changes both positive (increasing something) and negative (decreasing something), their reasons for changing, their steps in changing, how others can support them in their actions, what could go wrong and how they can stick with their plan despite these obstacles, and what good things will happen as a result of the changes they've specified.

17. A method to help people recover from addictive behaviors comprising the steps of:
keeping track of the users' use of the program and generating automated and personalized emails that encourage users to persist in their recovery plan; generating automated and personalized text messages that encourage users to persist in their recovery plan; generating personalized emails and text messages that remind them of their identified triggers and strategies they've chosen to deal with them, and reminders to pursue the pro-social activities they've chosen.

18. A method as set forth in claim 17 further comprising the step of: keeping track of the users' use of the program and generating automated and personalized emails that encourage users to persist in their recovery plan by monitoring who logs into the program on a daily basis and emailing users who have not logged in in the previous 7 days.

19. A method as set forth in claim 17 further comprising the steps of: the program generating personalized emails and text messages that remind users of their identified triggers and strategies they've chosen to deal with them.

20. A method as set forth in claim 17 further comprising the steps of: the program generating personalized emails and text messages that reminds users to pursue the pro-social activities they've chosen. These emails and text messages are set up by users as they identify and set up plans for managing their triggers to their drinking, drug use, or compulsive gambling.
